(19) United States
(12) Patent Application Publication
(10) Pub. No.: US 2002/0057190 A1
(43) Pub. Date: May 16, 2002

(54) RADIO WAVE RECEIVER WITH SUCCESSIVE TONE SOUNDING CAPABILITY

(76) Inventors: YOJI FUJIWARA, YOKOHAMA (JP); NORIYOSHI KATO, HAMAMATSU-SHI (JP)

Correspondence Address: LOWE HAUPTMAN GOPSTEIN, GILMAN AND BERNER LLP, SUITE 310, 1700 DIAGONAL ROAD, ALEXANDRIA, VA, 22314

(21) Appl. No.: 09/083,278

(22) Filed: May 22, 1998

(30) Foreign Application Priority Data
May 23, 1997 (JP) 9-148464

(51) Int. Cl. G08B 5/22

(52) U.S. Cl. 340/7.62; 340/384.2; 340/7.53

(57) ABSTRACT

A first pager is disclosed, which comprises: a paging signal receiving circuit; a display for displaying the data in the paging signal; and a sound generation circuit for successively generating one of a predetermined number of different tones in accordance with each of codes in the data. The frequency is controlled to provide at least a portion of a chromatic scale in accordance with each of codes or the sound generation circuit generates one of the voice tones selected in accordance with the each of the codes. A second pager is also disclosed, which further comprises a memory for storing a predetermined number of different sound data patterns; a registering portion, including a table, for storing the data in response to a registering command signal and storing a relation between the stored data and one of the predetermined number of different sound data patterns in response to a selection command; and a control portion for reading one of the predetermined number of different sound data patterns using the relation when the data from the paging signal receiving circuit agrees with the data from the registering portion to successively generate a tone according to the reading one of the sound data patterns. the data stored in the registering portion may be inputted by this pager.

### BACKGROUND OF THE INVENTION

1. Field of the Invention

This invention relates to a pager with an alert sound.

2. Description of the Prior Art

A pager having an alerting function for generating one of a plurality of predetermined sound selected in accordance with user's operation is known.

FIG. 9 is a block diagram of such a prior art pager. This pager generates an alert sound A when the received address agrees with one of the registered address number data in memory 113 by a speaker and generates an alert sound B when the received address does not agrees with any one of the registered address number data in memory 113.

### SUMMARY OF THE INVENTION

The aim of the present invention is to provide a superior pager.

According to the present invention, a first pager is provided, which comprises: a paging signal receiving circuit for receiving a paging signal directing to the pager, the paging signal including data including a plurality of codes; a display responsive to the paging signal receiving circuit and a display command for displaying the data from the paging signal receiving circuit; and a sound generation circuit for successively generating one of a predetermined number of different tones in accordance with each of the codes.

In the first pager, the sound generation circuit may successively generate the one of a predetermined number of different tones of which a frequency is controlled to provide at least a portion of a chromatic scale.

In the first pager, the sound generation circuit may comprise: a voice data memory for storing a set of voice tone data; a reading circuit for reading one of the voice tone data selected in accordance with the each of the codes; and a voice tone generation circuit for generating a voice tone as the one of a predetermined number of the different tones in accordance with the one of the voice tone data from the reading circuit.

According to the present invention, a second pager is provided, which comprises: a paging signal receiving circuit for receiving a paging signal directing to the pager, the paging signal including first data including a plurality of codes; a detection portion, including a memory for storing second data, for detecting whether at least a first portion of the first data agrees with the second data; a display for displaying at least a second portion of the first data from the paging signal receiving circuit when at least the first portion of the first data agrees with the second data, the second portion being determined by the first portion; and a sound generation circuit for successively generating one of a predetermined number of different tones in accordance with each of the codes in at least a third portion of the first data from the paging signal receiving circuit when at least the first portion of the first data agrees with the second data, the third portion being determined by the first portion.

In the second pager may further comprise a registering portion for storing the first data in the memory as the second data in response a registering command signal.

In the second pager, the sound generation circuit may successively generate the one of a predetermined number of different tones of which a frequency is controlled to provide at least a portion of a chromatic scale.

In the second pager, the sound generation circuit may comprise: a voice data memory for storing a set of voice tone data; a reading circuit for reading one of the voice tone data selected in accordance with the each of the codes in at least the third portion; and a voice tone generation circuit for successively generating a voice tone as the one of a predetermined number of the different tones in accordance with an output of the reading circuit.

In the second pager, the sound generation circuit may include a timer and successively generates the one of a predetermined number of different tones for a predetermined interval. In this case, the sound generation circuit may successively generate successively generates the one of a predetermined number of different tones for a predetermined interval in accordance with each of the codes in at least the third portion of the first data from the paging signal receiving circuit recurrently. In this case, the sound generation circuit may stop successively generating the one of a predetermined number of different tones for a predetermined interval in accordance with each of the codes in at least the third portion of the first data from the paging signal receiving circuit recurrently in response to a stop command.

According to the present invention, a third pager is provided, which comprises: a paging signal receiving circuit for receiving a paging signal directing to the pager, the paging signal including data; a display responsive to the paging signal receiving circuit for displaying the data from the paging signal receiving circuit; a memory for storing a predetermined number of different sound data patterns; a registering portion, including a table, for storing the data in response to a registering command signal and storing a relation between the stored data and one of the predetermined number of different sound data patterns in response to a selection command; a control portion, including comparing portion, for comparing the data from the paging signal receiving circuit with the data from the registering portion and reading one of the predetermined number of different sound data patterns using the stored relation when the data from the paging signal receiving circuit agrees with the data from the registering portion; and a sound generation circuit for successively generating a tone in accordance with the reading one of the predetermined number of different sound data patterns.

In the third pager, the sound generation circuit may successively generate the tone of which frequency is controlled to provide at least a portion of a chromatic scale.

In the third pager, the sound generation circuit may comprise: a voice data memory for storing a set of voice tone data; a reading circuit for reading one of the voice tone data selected in accordance with the reading one of the predetermined number of different sound data patterns; and a voice tone generation circuit for generating a voice tone as the tone in accordance with an output of the reading circuit.

According to the present invention, a fourth pager is provided, which comprises: a paging signal receiving circuit for receiving a paging signal directing to the pager, the paging signal including first data; a display responsive to the paging signal receiving circuit for displaying the data from the paging signal receiving circuit; a memory for storing a predetermined number of different sound data patterns; an input circuit for inputting second data; a registering portion, including a table, for storing the second data in response to a registering command signal and storing a relation between the second data from the input circuit and one of the predetermined number of different sound data patterns in response to a selection command; a control portion, including comparing portion, for comparing the first data from the paging signal receiving circuit with the second data from the registering portion and reading one of the predetermined number of different sound data patterns using the stored relation when the first data from the paging signal receiving circuit agrees with the second data from the registering circuit; and a sound generation circuit for successively generating a tone in accordance with the reading one of the predetermined number of different sound data patterns.

In the fourth pager, the sound generation circuit may successively generate the tone of which frequency is controlled to provide at least a portion of a chromatic scale.

In the fourth pager, the sound generation circuit may comprise: a voice data memory for storing a set of voice tone data; a reading circuit for reading one of the voice tone data selected in accordance with the reading one of the predetermined number of different sound data patterns; and a voice tone generation circuit for generating a voice tone as the tone in accordance with an output of the reading circuit.

### BRIEF DESCRIPTION OF THE DRAWINGS

The object and features of the present invention will become more readily apparent from the following detailed description taken in conjunction with the accompanying drawings in which:

FIG. 1 is a block diagram of a pager of a first embodiment;

FIG. 2 shows a table of the first embodiment;

FIG. 3 is a flow chart of the first embodiment showing an operation by a user to the pager of the first embodiment;

FIG. 4 is a illustration of the first embodiment showing a format of the data to be transmitted to the pager of the first embodiment;

FIG. 5 is a block diagram of a frequency signal generation circuit of a modification;

FIG. 6 is a block diagram of a pager of the second embodiment;

FIG. 7 is an illustration of the second embodiment showing data stored in the table shown in FIG. 6;

FIG. 8 depicts a flow chart of the second embodiment showing an operation to the pager of the second embodiment; and

FIG. 9 is a block diagram of such a prior art pager.

The same or corresponding elements or parts are designated with like references throughout the drawings.

### DETAILED DESCRIPTION OF THE INVENTION

Hereinbelow will be described a first embodiment of this invention.

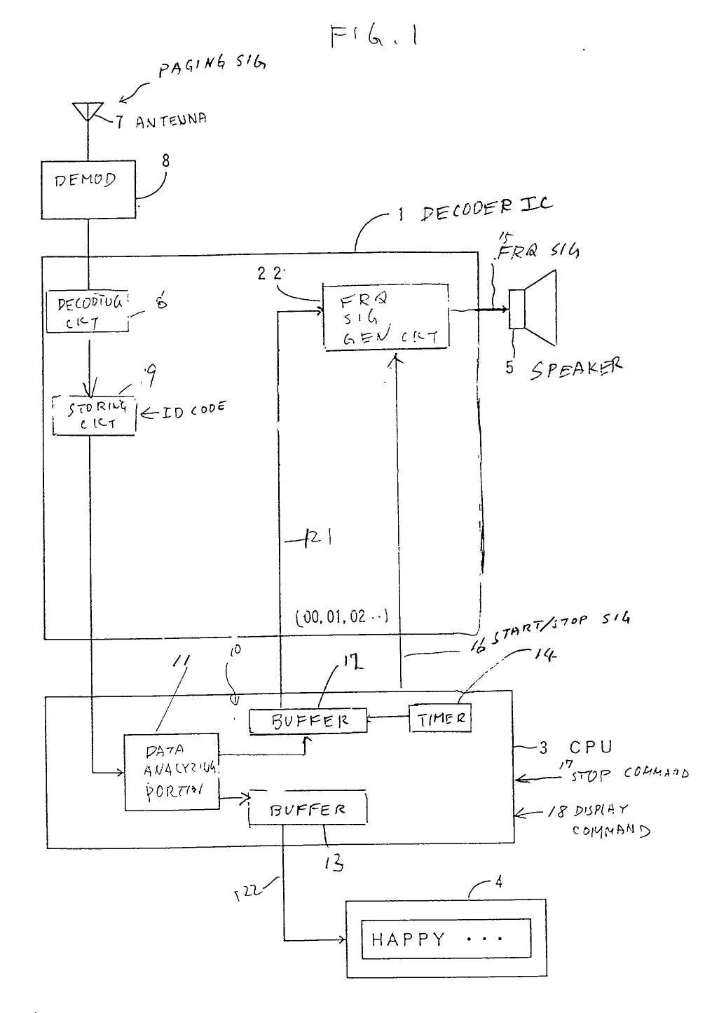

FIG. 1 is a block diagram of a pager of the first embodiment. The pager of the first embodiment comprises an antenna 7 for receiving a paging signal transmitted as a radio wave signal, a demodulation circuit 8 for demodulating the paging signal from the antenna 7, a decoding circuit 9 for decoding the demodulated paging signal, a storing circuit 9 for receiving a paging signal directing to the pager and storing the paging signal through comparing an identification code (address data) in the paging signal with the identification code assigned to the pager, the paging signal including first data including a plurality of codes, a separation portion 10 including a data analyzing portion 11, buffers 12 and 13 for separating data in the decode paging signal into sound data and sound data and storing the sound data in the buffer 12 and the message data in the buffer 13, a display 4 for displaying the message data from the buffer 12, and a frequency signal generation circuit 22 and a speaker 5 for successively generating one of a predetermined number of different tones in accordance with each code from the buffer 12 for a predetermined interval determined by a timer 13.

The antenna 7 receives the paging signal transmitted as a radio wave signal. The demodulation circuit 8 demodulates the paging signal from the antenna 7. The decoding circuit 6 decodes the demodulated paging signal. The storing circuit 9 stores the paging signal receiving for receiving the paging signal directing to the pager. That is, the identification code in the paging signal is compared with the identification code assigned to the pager. The paging signal includes first data including a plurality of codes. A CPU 3 includes the data separation portion (program) 10, a data analyzing portion 11, the buffers 12 and 13, and the timer 14.

The separation portion 10 analyzes the data from the storing circuit 9 and separates it into sound data and sound data and stores the sound data in the buffer 12 and the message data in the buffer 13. The display 4 displays the message data from the buffer 13. The frequency signal generation circuit 22 and the speaker 5 successively generates one of a predetermined number of different tones in accordance with each code in the sound data from the buffer 12 for the predetermined interval determined by the timer 13. That is, the frequency signal generation circuit 22 generates a frequency signal 15 and the speaker 5 generates the tone in response to the frequency signal. As the frequency signal generation circuit 22, a melody IC may be used for generating chromatic scale sounds.

FIG. 2 shows a table of the first embodiment.

Each code of the sound data includes two digits. That is, “00” represents a tone of “C” and “05” represents a tone of “A” of which frequency is 440 Hz for example. Then, a series of tones is generated in accordance with the digits show in the table in FIG. 2 forms a chromatic scale.

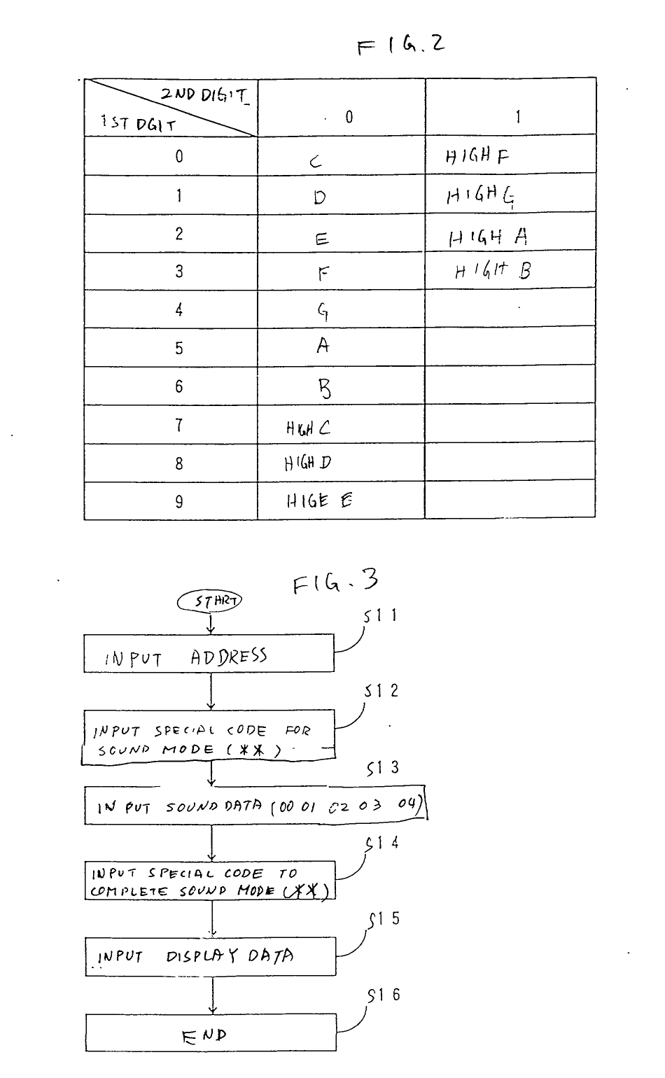

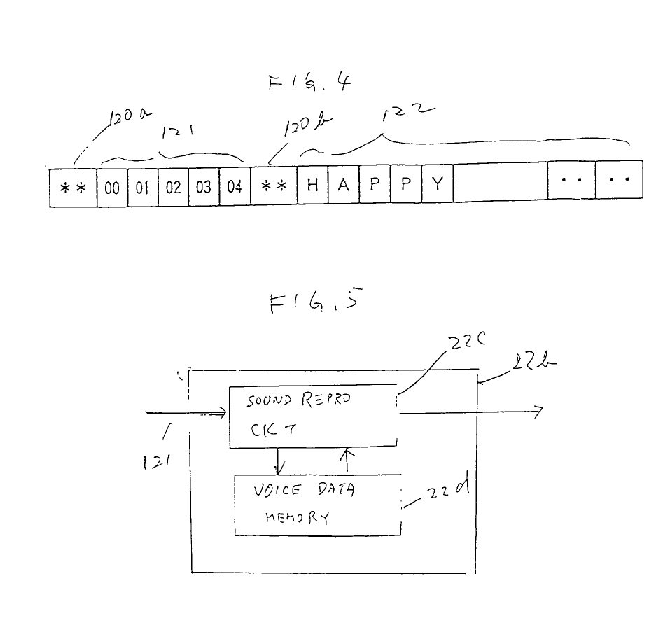

FIG. 3 is a flow chart of the first embodiment showing an operation by a user to the pager of the first embodiment. A user generates and transmits the sound data and the message data in accordance with the operation shown in FIG. 3. FIG. 4 is a illustration of the first embodiment showing a format of the data to be transmitted to the pager inputted by the operation in accordance with the flow chart shown in FIG. 3.

The user input an address (identification code) by operating keys on a telephone (not shown) connected to a public telephone network in step sll. Then, the user inputs “**” as a special code for identifying the sound data in step s12 and then, inputs sound data for example “00 01 02 03 04” in step s13. Then, the user inputs “**” again to indicate completion of the sound data in step s14. That is, the sound data is sandwiched between the special codes “**”. In the following step s15, the user further inputs display (message) data and ends the operation in step s16.

The data inputted and transmitted as mentioned is shown in FIG. 4. That is, the sound data is indicated by the special codes “**” and the message data following to the sound data is to be displayed on the display 4.

When the data shown in FIG. 4 is received by the pager of the first embodiment, the data analyzing portion 11 detects the special codes “**” 120a and 120b and stores the sound data 121 indicated by the special codes “**” 120a and 120b in the buffer 12 and stores the message data 22 “HAPPY .” following to the special code “**” 120b in the buffer 13. The sound data is read in response to the timer 14 every a predetermined interval. If the message data does not include the special codes 120a and 120b, a conventional alert sound is generated.

The message data is displayed on the display 4 in response to reception of the paging signal or a display command 18. The tones from the speaker 5 is stopped in response to a stop command 17.

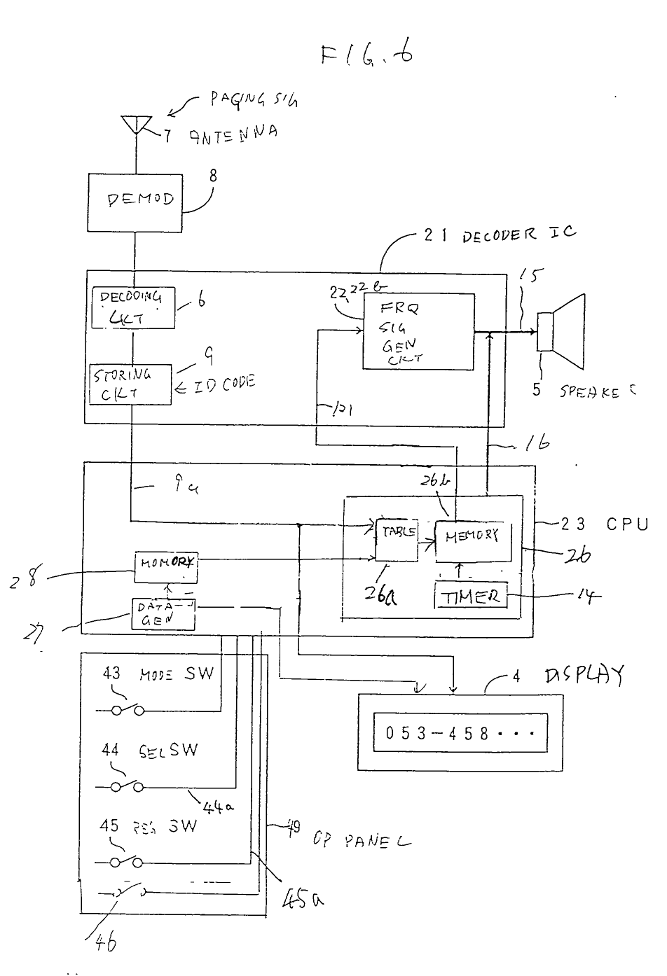

Modification will be described. FIG. 5 is a block diagram of a frequency signal generation circuit of a modification. The frequency signal generation circuit 22b includes a sound reproducing circuit 22c and a voice data memory 22d. The sound reproducing circuit 22c generates a voice tone in accordance with the sound data 121. In this case, the codes including two digits shown in FIG. 2 is assigned to each voice sound.

As described, the pager can receive a sound message and can display the message.

A second embodiment will be described.

FIG. 6 is a block diagram of a pager of the second embodiment.

The pager of the second embodiment comprises a paging signal receiving portion including the antenna 7, a demodulator 8, and a decoding circuit 6, a storing circuit 9 for receiving a paging signal directing to the pager, the paging signal including first data (message data), the display 4 responsive to the paging signal receiving portion for displaying the first data from the paging signal receiving portion, a CPU 23 including a memory 26b for storing a predetermined number of different sound data patterns and a table 26a for storing the first data in response to a registering command signal 45 as second data and storing a relation between the stored data and one of the predetermined number of different sound data patterns in response to a selection command 44a, a control portion 26 for comparing the first data with the registered data in the table 26a and reading one of the predetermined number of different sound data patterns in the memory 26b using the stored relation when the first data from the paging signal receiving portion agrees with the second data from the table 26a, the sound generation circuit 22 or 22b for successively generating a tone in accordance with the reading one of the predetermined number of different sound data patterns from the memory 26b and outputting a sound from the speaker 5.

The paging signal receiving portion receives the paging signal directing to the pager. The display 4 displays the first data 9a from the paging signal receiving portion. The memory 26b stores a predetermined number of different sound data patterns. The table 26a stores the first data 9a as the second data and stores a relation between the stored data and one of the predetermined number of different sound data patterns in response to the registering command signal 45a from registering switch 45 and a selection command 44a from a selection switch 44. The control portion 26 compares the first data 9a with data registered in the table 26a and reading one of the predetermined number of different sound data patterns using the stored relation in the table 26a when the first data from the paging signal receiving portion agrees with the data from the table 26a. That is, when the first data 9a from the paging signal receiving portion agrees with the data in the table 26a, one of the predetermined number of different sound data patterns is read in accordance with the relation stored in the table 26a. The sound generation circuit 22 or 22b successively generates a tone in accordance with the reading one of the predetermined number of different sound data patterns from the memory 26b and outputs a sound from the speaker 5.

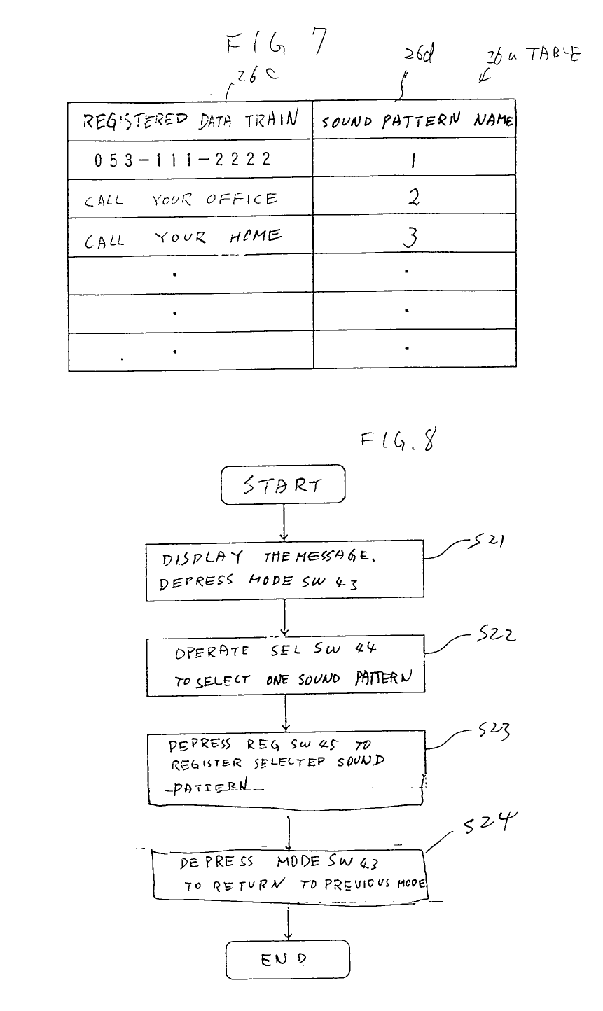

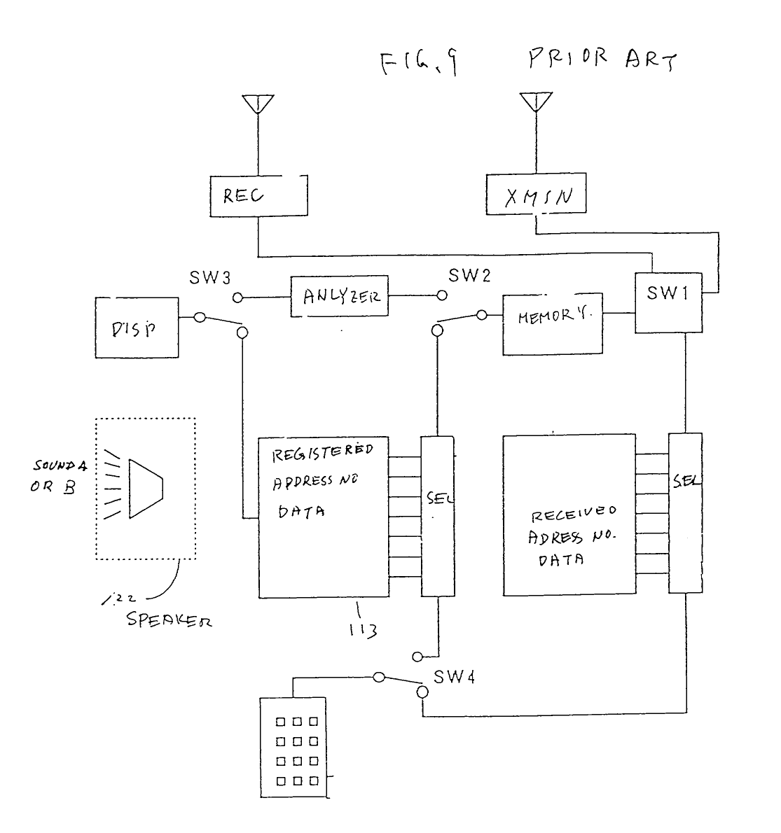

FIG. 7 is an illustration of data stored in the table shown in FIG. 6. FIG. 8 shows a flow chart of the second embodiment showing an operation to the pager of the second embodiment.

The message data to be stored is displayed on the display 4 in response to the paging signal receiving portion or a display switch 46 and the user depresses a mode switch 43 and the selection switch 44 to enter the registering mode in step s21. In response to the mode switch the pager stores the displayed message data in the table 26a. In the following step s22, the user operates the selection switch 44 to display image data of one of the sound patterns and the pager scrolls to successively display the sound patterns in response to the selection switch 44. When the user finds the desired one of the sound data pattern, the user depresses the registering switch 45 in step s23 and then, the pager stores the relation between the registered message data in the table 26a and the desired one of the sound data pattern. Then, the user depresses the mode switch 43 to return to the previous mode. FIG. 7 shows this relation. After the registering operation, when the message data is received and compared with each of the registered data train 26c by the control portion 26. When the received message data agrees with one of the registered data train, the sound pattern name data is supplied to the memory 26b. The memory 26b outputs the sound data pattern corresponding to the sound pattern name data 26d.

In the second embodiment, as similar to the first embodiment, the frequency signal generation circuit 22 generates a tone of which frequency is controlled in accordance with one of the sound data patterns corresponding to the first data 9a and if the frequency signal generation circuit 22b shown in FIG. 5 is used, a voice sound is generated in accordance with one of the sound patterns corresponding to the first data 9a. If the message data does not agree with any of the registered message data, the control portion 26 generates the conventional alert sound.

Moreover, the pager of the second embodiment can prepare a message to be registered the table 26a.

The user operates the mode switch 43 and the selection switch 44 to enter a message preparing mode. A data generation portion generates one of character data and displays it on the display 4. The data generator 27 scrolls the display image to select one of the character data desired by the user in response to the selection switch 44. When the character displayed on the display 4 is desired one, the user depresses the selection switch 44 to stored the displayed character is stored in a memory 28. This operation is repeated to prepare a message which is stored in the memory 28. When the message has been prepared, the user depress the registering switch 45. In response to this, the prepared message data is supplied to the table 26a and registered. Then, the user registers one of the sound data patterns corresponding to the prepared message data in the sound data pattern registering operation as shown in FIG. 8. When the first data 9a agrees with one of the registered messages which was prepared by the operation by the user, the corresponding sound data pattern is reproduced.

What is claimed is:

1. A pager comprising:
paging signal receiving means for receiving a paging signal directing to said pager, said paging signal including data including a plurality of codes;
display means responsive to said paging signal receiving means and a display command for displaying said data from said paging signal receiving means; and
sound generation means for successively generating one of a predetermined number of different tones in accordance with each of said codes.

2. The pager as claimed in claim 1, wherein said sound generation means successively generates said one of a predetermined number of different tones of which a frequency is controlled to provide at least a portion of a chromatic scale.

3. The pager as claimed in claim 1, wherein said sound generation means comprises:
voice data storing means for storing a set of voice tone data;
reading means for reading one of said voice tone data selected in accordance with said each of said codes; and
voice tone generation means for generating a voice tone as said one of a predetermined number of said different tones in accordance with said one of said voice tone data from said reading means.

4. A pager comprising:
paging signal receiving means for receiving a paging signal directing to said pager, said paging signal including first data including a plurality of codes;
detection means, including storing means for storing second data, for detecting whether at least a first portion of said first data agrees with said second data;
display means for displaying at least a second portion of said first data from said paging signal receiving means when at least said first portion of said first data agrees with said second data, said second portion being determined by said first portion; and
sound generation means for successively generating one of a predetermined number of different tones in accordance with each of said codes in at least a third portion of said first data from said paging signal receiving means when at least said first portion of said first data agrees with said second data, said third portion being determined by said first portion.

5. The pager as claimed in claim 4, further comprising registering means for storing said first data in said storing means as said second data in response a registering command signal.

6. The pager as claimed in claim 4, wherein said sound generation means successively generates said one of a predetermined number of different tones of which a frequency is controlled to provide at least a portion of a chromatic scale.

7. The pager as claimed in claim 4, wherein said sound generation means comprises:
voice data storing means for storing a set of voice tone data;
reading means for reading one of said voice tone data selected in accordance with said each of said codes in at least said third portion; and
voice tone generation means for successively generating a voice tone as said one of a predetermined number of said different tones in accordance with an output of said reading means.

8. The pager as claimed in claim 4, wherein said sound generation means includes timer means and successively generates said one of a predetermined number of different tones for a predetermined interval.

9. The pager as claimed in claim 8, wherein said sound generation means successively generates successively generates said one of a predetermined number of different tones for a predetermined interval in accordance with each of said codes in at least said third portion of said first data from said paging signal generation means recurrently.

10. The pager as claimed in claim 9, wherein said sound generation means stops successively generating said one of a predetermined number of different tones for a predetermined interval in accordance with each of said codes in at least said third portion of said first data from said paging signal generation means recurrently in response to a stop command.

11. A pager comprising:
paging signal receiving means for receiving a paging signal directing to said pager, said paging signal including data;
display means responsive to said paging signal receiving means for displaying said data from said paging signal receiving means;
storing means for storing a predetermined number of different sound data patterns;
registering means, including table means, for storing said data in response to a registering command signal and storing a relation between said stored data and one of said predetermined number of different sound data patterns in response to a selection command;
control means, including comparing means, for comparing said data from said paging signal receiving means with said data from said registering means and reading one of said predetermined number of different sound data patterns using said stored relation when said data from said paging signal receiving means agrees with said data from said registering means; and
sound generation means for successively generating a tone in accordance with the reading one of said predetermined number of different sound data patterns.

12. The pager as claimed in claim 11, wherein said sound generation means successively generates said tone of which frequency is controlled to provide at least a portion of a chromatic scale.

13. The pager as claimed in claim 11, wherein said sound generation means comprises:
voice data storing means for storing a set of voice tone data;
reading means for reading one of said voice tone data selected in accordance with the reading one of said predetermined number of different sound data patterns; and
voice tone generation means for generating a voice tone as said tone in accordance with an output of said reading means.

14. A pager comprising:
paging signal receiving means for receiving a paging signal directing to said pager, said paging signal including first data;
display means responsive to said paging signal receiving means for displaying said data from said paging signal receiving means;
storing means for storing a predetermined number of different sound data patterns;
input means for inputting second data;
registering means, including table means, for storing said second data in response to a registering command signal and storing a relation between said second data from said input means and one of said predetermined number of different sound data patterns in response to a selection command;
control means, including comparing means, for comparing said first data from said paging signal receiving means with said second data from said registering means and reading one of said predetermined number of different sound data patterns using said stored relation when said first data from said paging signal receiving means agrees with said second data from said registering means; and
sound generation means for successively generating a tone in accordance with the reading one of said predetermined number of different sound data patterns.

15. The pager as claimed in claim 14, wherein said sound generation means successively generates said tone of which frequency is controlled to provide at least a portion of a chromatic scale.

16. The pager as claimed in claim 14, wherein said sound generation means comprises:
voice data storing means for storing a set of voice tone data;
reading means for reading one of said voice tone data selected in accordance with the reading one of said predetermined number of different sound data patterns; and
voice tone generation means for generating a voice tone as said tone in accordance with an output of said reading means.
